(19) United States
(12) Patent Application Publication
(10) Pub. No.: US 2016/0133268 A1
(43) Pub. Date: May 12, 2016

(54) METHOD, ELECTRONIC DEVICE, AND COMPUTER PROGRAM PRODUCT

(71) Applicant: Kabushiki Kaisha Toshiba, Tokyo (JP)

(72) Inventor: Ryuichi YAMAGUCHI, Ome Tokyo (JP)

(21) Appl. No.: 14/681,995

(22) Filed: Apr. 8, 2015

(30) Foreign Application Priority Data
Nov. 7, 2014 (JP) 2014-227270

(51) Int. Cl. G10L 21/00; G10L 21/10

(52) U.S. Cl. CPC G10L 21/00; G10L 21/10

(57) ABSTRACT

According to one embodiment, a method of an electronic device for outputting a sound from loudspeakers includes: recording an audio signal comprising voice sections; displaying the voice sections, wherein speakers of the voice sections are visually distinguishable; designating a first voice section of a first speaker; designating a second voice section of a second speaker; outputting signals of the first voice section from the loudspeakers in a first output form; and outputting signals of the second voice section from the loudspeakers in a second output form different from the first output form.

### CROSS-REFERENCE TO RELATED APPLICATIONS

This application is based upon and claims the benefit of priority from Japanese Patent Application No. 2014-227270, filed Nov. 7, 2014, the entire contents of which are incorporated herein by reference.

### FIELD

Embodiments described herein relate generally to, a method, an electronic device, and a computer program product.

### BACKGROUND

Conventionally, there has been known a technique that records audio signals including a plurality of voice sections of a plurality of speakers, and reproduces the recorded audio signals.

In the above-described technique, it is useful if a section specified by a user is auditorily distinguishable from other sections.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view illustrating the external appearance configuration of a portable terminal according to an embodiment;

FIG. 2 is an exemplary block diagram illustrating the internal configuration of the portable terminal in the embodiment;

FIG. 3 is an exemplary block diagram illustrating the functional configuration of a recording/reproduction program executed by the portable terminal in the embodiment;

FIG. 4 is an exemplary view illustrating an image displayed on a display when the portable terminal reproduces a voice sound recorded therein, in the embodiment;

FIG. 5 is an exemplary view for explaining the outline of a stereophonic technique used by the portable terminal in the embodiment;

FIG. 6 is an exemplary view illustrating one example of an image for a user to set an arrival direction of the voice sound for each speaker using the portable terminal in the embodiment;

FIG. 7 is an exemplary view illustrating another example of an image for a user to set the arrival direction of the voice sound for each speaker using the portable terminal in the embodiment;

FIG. 8 is an exemplary flowchart illustrating processing performed when the portable terminal reproduces a voice sound recorded therein, in the embodiment; and

FIG. 9 is an exemplary flowchart illustrating processing performed by the portable terminal when the arrival direction of the voice sound for each speaker is set, in the embodiment.

### DETAILED DESCRIPTION

In general, according to one embodiment, a method of an electronic device for outputting a sound from loudspeakers comprises: recording an audio signal comprising voice sections; displaying the voice sections, wherein speakers of the voice sections are visually distinguishable; designating a first voice section of a first speaker; designating a second voice section of a second speaker; outputting signals of the first voice section from the loudspeakers in a first output form; and outputting signals of the second voice section from the loudspeakers in a second output form different from the first output form.

Hereinafter, an embodiment is explained in conjunction with drawings.

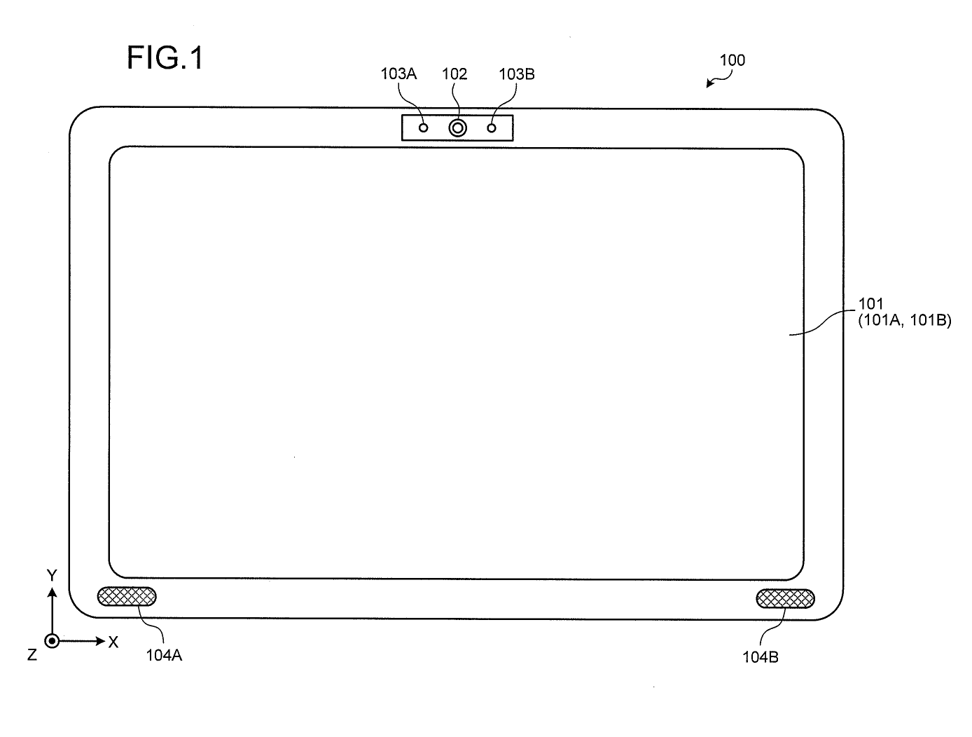

First, in reference to FIG. 1, the external appearance configuration of a portable (handheld) terminal 100 according to the embodiment is explained. The portable terminal 100 is one example of an “electronic device”. FIG. 1 illustrates the external appearance of the portable terminal 100 implemented as a tablet computer. Here, the technique in the embodiment is applicable to a portable terminal other than the tablet computer, such as a smart phone, and also applicable to a general stationary information processing device provided that the portable terminal or the information processing device is an electronic device provided with a loudspeaker.

As illustrated in FIG. 1, the portable terminal 100 comprises a display module 101, a camera 102, a microphones 103A and 103B, and loudspeakers 104A and 104B.

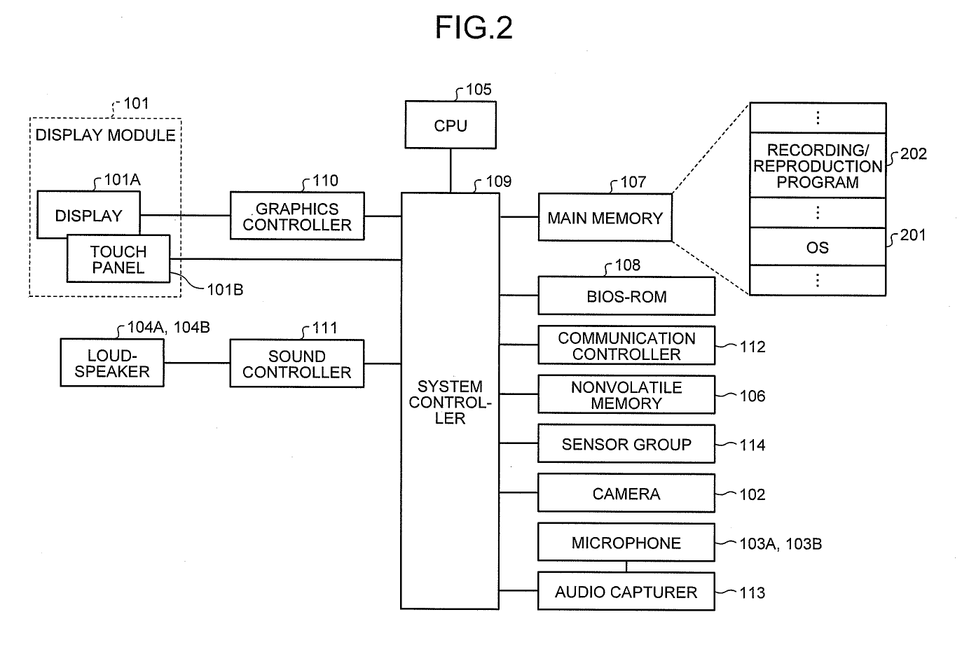

The display module 101 has a function as an output device that displays (outputs) an image such as a static image or an moving image, and a function as an input device that receives a user's operation (touch operation). To be more specific, as illustrated in FIG. 2 mentioned later, the display module 101 comprises a display 101A for displaying an image such as a static image or a moving image, and a touch panel 101B that functions as an operation module for performing various kinds of operations (touch operation) on the portable terminal 100.

The camera 102 is an imaging device for acquiring an image of a region located on the front side (Z-direction side) of the camera 102. Each of the microphones 103A and 103B is a sound-collecting device for acquiring a voice sound (an audio signal) of a user around the display module 101. Each of the loudspeakers 104A and 104B is an output device for outputting a voice sound. Here, FIG. 1 illustrates the example in which the two loudspeakers 104A and 104B are arranged. However, in the embodiment, the total number of the loudspeakers may be one, or maybe three or more. In the same manner as above, in the embodiment, the total number of the microphones may be one, or may be three or more.

Next, the internal configuration of the portable terminal 100 is explained with reference to FIG. 2.

As illustrated in FIG. 2, the portable terminal 100 comprises, a CPU 105, a nonvolatile memory 106, a main memory 107, a BIOS-ROM 108, a system controller 109, a graphics controller 110, a sound controller 111, a communication controller 112, an audio capturer 113, and a sensor group 114 in addition to the display module 101, the camera 102, the microphones 103A and 103B, and the loudspeakers 104A and 104B that are mentioned above.

The CPU105 is a processor similar to a processor used in a general computer, and configured to control each module in the portable terminal 100. The CPU 105 is configured to execute various kinds of software loaded on the main memory 107 from the nonvolatile memory 106 that is a storage device. FIG. 2 illustrates an operating system (OS) 201 and a recording/reproduction program 202 as examples of software loaded on the main memory 107. The recording/reproduction program 202 is specifically described later.

The CPU 105 is also configured to execute a basic input/output system program (BIOS program) stored in the BIOS-ROM 108. Here, the BIOS program is a computer program for controlling hardware.

The system controller 109 is a device for connecting the local bus of the CPU 105 and each component comprised in the portable terminal 100.

The graphics controller 110 is a device that controls the display 101A. The display 101A is configured to display a screen image (an image such as a static image or a moving image) based on a display signal input from the graphics controller 110.

The sound controller 111 is a device that controls the loudspeakers 104A and 104B. Each of the loudspeakers 104A and 104B is configured to output a voice sound based on a voice signal input from the sound controller 111.

The communication controller 112 is a communication device for performing wireless or wired communication via a LAN or the like. The audio capturer 113 is a signal processing device that performs various kinds of signal processing with respect to voice sounds acquired by the microphones 103A and 103B.

The sensor group 114 comprises an acceleration sensor, an azimuth sensor, a gyro sensor, and the like. The acceleration sensor is a detection device that detects a direction and a level of the acceleration of the portable terminal 100 when the portable terminal 100 is moved. The azimuth sensor is a detection device that detects the azimuth of the portable terminal 100. The gyro sensor is a detection device that detects the angular velocity (rotational angle) of the portable terminal 100 when the portable terminal 100 is rotated.

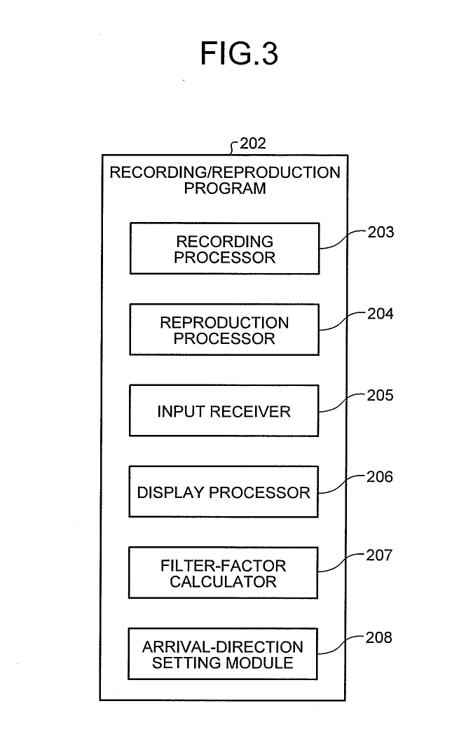

Next, in reference to FIG. 3, the functional configuration of the recording/reproduction program 202 executed by the CPU105 is explained. The recording/reproduction program 202 has a modular configuration as explained hereinafter.

As illustrated in FIG. 3, the recording/reproduction program 202 comprises a recording processor 203, a reproduction processor 204, an input receiver 205, a display processor 206, a filter-factor calculator 207, and an arrival-direction setting module 208. Each of the modules is generated on the main memory 107 as a result of the execution of the recording/reproduction program 202 read out from the nonvolatile memory 106 by the CPU105 of the portable terminal 100.

The recording processor 203 is configured to perform processing of recording a voice signal (records a voice sound) acquired via the microphones 103A and 103B. The recording processor 203 according to the embodiment is configured to be capable of recording, when recording a voice sound including a plurality of voice sections of a plurality of speakers, the voice sound simultaneously with information indicating the positional relationship between the respective speakers; that is, information indicating a direction from which each speaker inputs the voice sound thereof to the microphone.

The reproduction processor 204 is configured to perform processing of reproducing (outputting) a voice sound recorded by the recording processor 203 (hereinafter, referred to as “recorded voice sound”). The input receiver 205 is configured to perform processing of receiving the input operation of a user via the touch panel 101B or the like. The display processor 206 is configured to perform processing of controlling display data to be output to the display 101A.

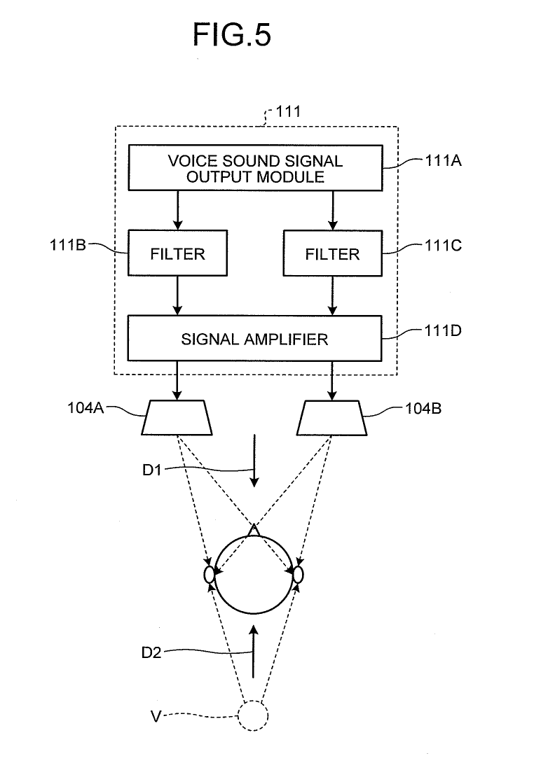

The filter-factor calculator 207 is configured to perform processing of calculating a filter factor to be set to each of filters 111B and 111C (see FIG. 5) described later. The arrival-direction setting module 208 is configured to perform processing of setting or changing an arrival direction described later.

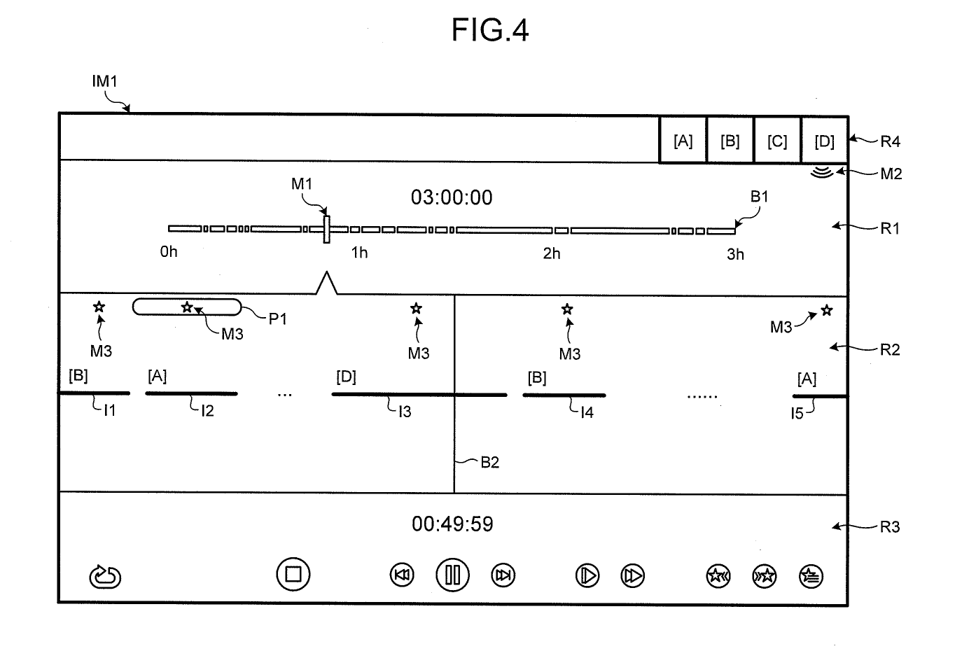

Here, the display processor 206 according to the embodiment is configured to output, when the reproduction processor 204 performs the processing of reproducing a recorded voice sound, such an image IM1 as illustrated in FIG. 4 to the display 101A. The image IM1 displays a plurality of voice sections of a plurality of speakers distinguishably (in a distinguishable manner). The voice sections are included in the recorded voice sound.

The image IM1 comprises a region R1 that displays the approximate status of the recorded voice sound, a region R2 that displays the detailed status of the recorded voice sound, and a region R3 that displays various kinds of manual operation buttons for performing operations such as starting, stopping, or the like of the reproduction of the recorded voice sound.

The region R1 displays a bar B1 indicating a whole recorded voice sound, and a mark M1 indicating a current reproduction position. The region R1 also displays the time length of the recorded voice sound (see the display of “03:00:00”).

The region R2 displays details of the recorded voice sound in the predetermined period before and after the current reproduction position. In the example illustrated in FIG. 4, the region R2 indicates that a voice section I1 of a speaker [B], a voice section I2 of a speaker [A] , a voice section I3 of a speaker [D], a voice section I4 of the speaker [B], and a voice section I5 of the speaker [A] are included in the predetermined period before and after the current reproduction position. These voice sections I1 to I5 may be displayed in a color-coded manner for each speaker.

A bar B2 displayed in the center of the region R2 indicates the current reproduction position. In the example illustrated in FIG. 4, since the bar B2 is overlapped with the voice section I3 of the speaker [D], it is understood that the speaker of the voice sound that is currently reproduced is [D]. Here, the image IM1 comprises a region R4 for displaying each speaker of each voice section included in the recorded voice sound. In the example illustrated in FIG. 4, a mark M2 indicating the speaker of the voice sound that is currently reproduced is displayed near the display of [D] in the region R4, thereby it is understood that the speaker of the voice sound that is currently reproduced is [D].

Furthermore, the region R2 displays a plurality of star marks M3 arranged so as to correspond to the respective voice sections I1 to I5. These marks M3 are, for example, used for marking (what is called tagging) to enable later extraction and reproduction of only a designated voice section. In the example illustrated in FIG. 4, an elongated area P1 is displayed around the mark M3 corresponding to the voice section I2. Accordingly, in the example illustrated in FIG. 4, it is understood that a user performs tagging with respect to the voice section I2 by touching the mark M3 corresponding to the voice section I2.

Furthermore, the region R3 displays a time (see the display of “00:49:59”) to indicate the current reproduction position in the whole recorded voice sound in addition to the operation buttons for performing operations such as starting, stopping, or the like of the reproduction of the recorded voice sound.

Here, the reproduction processor 204 in the embodiment is configured to be capable of making, when reproducing a recorded voice sound comprising a first voice section specified by a user, an output form of a first voice sound of the first voice section different from an output form of a second voice sound of a second voice section other than the first voice section.

For example, the reproduction processor 204 in the embodiment is configured to reproduce a recorded voice sound by using what is called stereophonic technique so as to allow a user to feel that the voice sound in the voice section tagged by the user on the image IM1 illustrated in FIG. 4 is heard from behind the user, and so as to allow the user to feel that the voice sound in the voice section not tagged by the user is heard from the front side of the user.

Here, in reference to FIG. 5, the outline of the stereophonic technique is briefly explained.

As illustrated in FIG. 5, the sound controller 111 (see FIG. 2) according to the embodiment comprises a voice sound signal output module 111A, two filters 111B and 111C, and a signal amplifier 111D. In the stereophonic technique, the filter factors set to the respective two filters 111B and 111C are changed thus controlling the arrival direction of the voice sound that a user is allowed to feel.

The filter-factor calculator 207 calculates a filter factor based on a head-related transfer function depending on the positional relationship among the loudspeakers 104A and 104B and a user, and a head-related transfer function depending on the positional relationship between a virtual source V corresponding to the arrival direction to be set and the user.

For example, when allowing a user to feel that the voice sounds output from the respective two loudspeakers 104A and 104B are heard from behind the user, the filter-factor calculator 207 sets the virtual source V to the position illustrated in FIG. 5, and calculates the filter factors to be set to the respective two filters 111B and 111C by use of two head-related transfer functions from the position of one loudspeaker 104A to the respective positions of both the user's ears, two head-related transfer functions from the position of the other loudspeaker 104B to the respective positions of both the user's ears, and two head-related transfer functions from the position of the virtual source V to the respective positions of both the user's ears. Furthermore, the reproduction processor 204 sets the calculated filter factors to the respective filters 111B and 111C thus providing a phase difference, a volume difference, or the like between two voice sounds output from the respective two loudspeakers 104A and 104B so as to allow the user to feel that the voice sounds output from the respective two loudspeakers 104A and 104B are heard from the virtual source V. In the embodiment, the explanation is made assuming that a plurality of head-related transfer functions corresponding to various circumstances are stored in the portable terminal 100 in advance.

As described above, the reproduction processor 204 in the embodiment is configured to be capable of providing at least a phase difference between two voice sounds so that the two voice sounds are enhanced with each other in a second direction (a direction D2 in FIG. 5) other than a first direction (a direction D1 in FIG. 5) toward the portable terminal 100, the two voice sounds being output from the respective two loudspeakers 104A and 104B based on the first voice sound of the first voice section specified by a user.

Furthermore, the reproduction processor 204 in the embodiment is configured to be capable of reproducing recorded voice sounds by using the above-mentioned stereophonic technique so as to allow a user to feel that voice sounds of respective voice sections are heard from respective arrival directions different from each other for each speaker. Here, the arrival direction of the voice sound for each speaker is set by default based on a positional relationship between respective speakers that is acquired by the recording processor 203 at the time of recording a voice sound. Furthermore, the arrival direction of a voice sound for each speaker, set by default, can be changed by a user's operation. The processing of setting and changing the arrival direction is performed by the arrival-direction setting module 208.

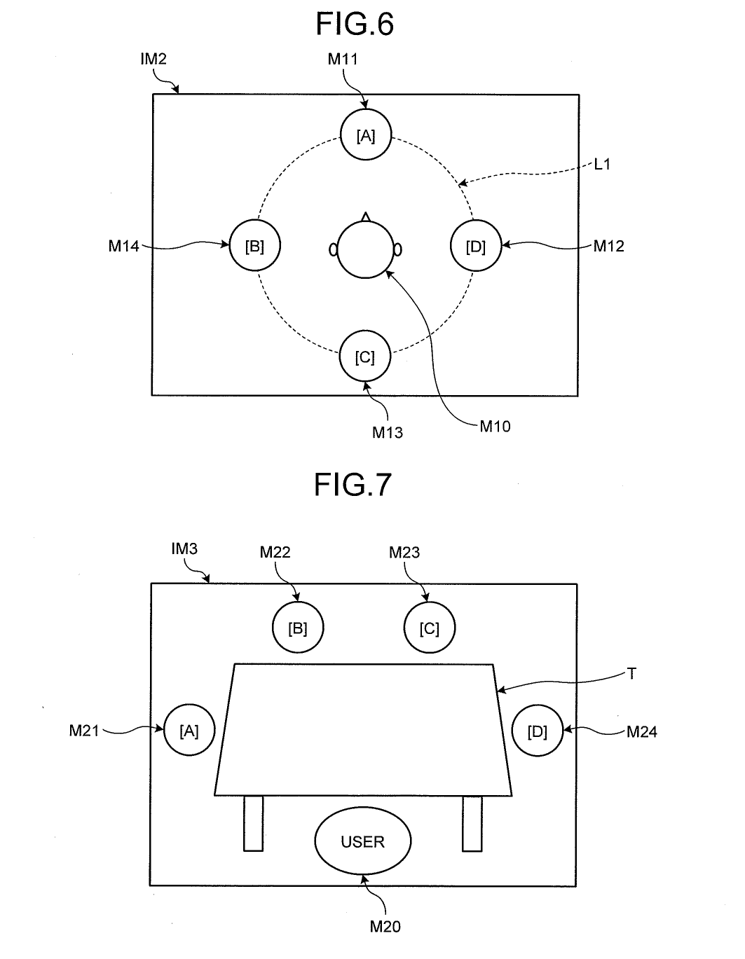

For example, the display processor 206 in the embodiment is, in order to allow a user to set an arrival direction of a voice sound for each speaker, configured to be capable of displaying an image IM2 illustrated in FIG. 6, an image IM3 illustrated in FIG. 7, or the like on the display 101A.

The image IM2 in FIG. 6 displays thereon a mark M10 indicating a user's position, and an annular dotted line L1 surrounding the mark M10. Furthermore, on the dotted line L1, marks M11 to M14 indicating respective positions of speakers [A] to [D] with respect to a user are displayed. The user performs a drag operation to move each of the marks M11 to M14 along the dotted line L1 thus changing the arrival direction of the voice sound of each of the speakers [A] to [D]. Here, in the example illustrated in FIG. 6, the arrival direction of the voice sound for each speaker is set so that the voice sound of the speaker [A], the voice sound of the speaker [B], the voice sound of the speaker [C], and the voice sound of the speaker [D] are heard from the front side of the user, the left side of the user, behind the user, and the right side of the user, respectively.

Similarly to the above, on the image IM3 illustrated in FIG. 7, a mark M20 indicating the position of a user, and marks M21 to M24 indicating the respective positions of the speakers [A] to [D] situated across a table T from the user are displayed. The user performs a drag operation to move each of the marks M21 to M24 thus changing the arrival direction of the voice sound of each of the speakers [A] to [D]. Here, in the example illustrated in FIG. 7, the arrival direction of the voice sound for each speaker is set so that the voice sound of the speaker [A], the voice sound of the speaker [B], the voice sound of the speaker [C], and the voice sound of the speaker [D] are heard across a table T from a left side of the user, across the table T from a position on a side opposite to the user and also on a slightly left side of the user, across the table T from a position on a side opposite to the user and also on a slightly right side of the user, and across the table T from a right side of the user, respectively.

The filter-factor calculator 207 in the embodiment is configured to calculate, in order to allow a user to feel that voice sounds are heard from respective arrival directions different from each other for each speaker, a different filter factor for each speaker based on an arrival direction corresponding to the positional relationship between respective speakers that is acquired at the time of recording the voice sound, a setting of an arrival direction via the image IM2 in FIG. 6 or the image IM3 in FIG. 7, or the like. Furthermore, the reproduction processor 204 is configured to change the filter factors to be set to the respective filters 111B and 111C for each time when the speaker of a voice sound to be reproduced is changed thus changing a phase difference, a volume difference, or the like provided between two voice sounds output from the respective two loudspeakers 104A and 104B so that a user is allowed to feel that the voice sounds output from the respective two loudspeakers 104A and 104B are heard from the respective arrival directions different from each other for each speaker.

That is, the reproduction processor 204 in the embodiment is configured to be capable of providing at least a phase difference between output sounds so that a third direction and a fourth direction are different from each other. The third direction is a direction in which two voice sounds output from respective two loudspeakers 104A and 104B based on the voice section of a first speaker out of a plurality of speakers are enhanced each other. The fourth direction is a direction in which the two voice sounds output from the respective two loudspeakers 104A and 104B based on the voice section of a second speaker different from the first speaker are enhanced each other. Furthermore, the arrival-direction setting module 208 in the embodiment is configured to be capable of setting these output directions based on the positional relationship between the first speaker and the second speaker that is acquired at the time of recording a voice sound, or a user's operation.

The above explanation is made with respect to the example that uses the stereophonic technique in order to allow a user to auditorily distinguish the first voice sound of the first voice section specified by a user from the second voice sound other than the first voice sound. However, in the embodiment, the first voice sound and the second voice sound may be made different in volume from each other so as to allow a user to auditorily distinguish the first voice sound from the second voice sound without using the stereophonic technique. As a matter of course, the first voice sound and the second voice sound may be made different in volume from each other while using the stereophonic technique so as to allow a user to auditorily distinguish the first voice sound from the second voice sound.

Furthermore, the above explanation is made with respect to the example that arrival directions are set so as to allow a user to feel that the first voice sound is heard from behind the user and the second voice sound is heard from the front side of the user thus allowing the user to auditorily distinguish the first voice sound from the second voice sound. However, in the embodiment, any arrival direction may be set provided that a user is allowed to auditorily distinguish the first voice sound from the second voice sound; that is, the user is allowed to feel that the first voice sound and the second voice sound are heard from respective arrival directions that are different from each other. Here, when a user and the portable terminal 100 face each other in an opposed manner, a voice sound from the portable terminal 100 is normally heard from the front side of the user. Therefore, if an arrival direction is set so as to allow a user to feel that the first voice sound is heard from behind the user, it is easy to attract the attention of the user when the first voice sound is reproduced.

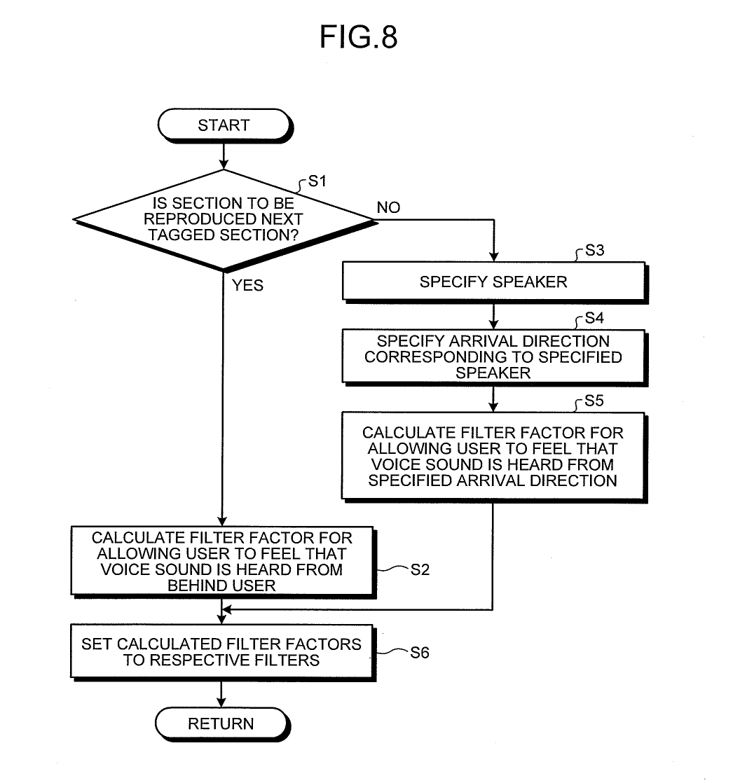

Next, in reference to FIG. 8, the explanation is made with respect to a processing flow that is performed by the CPU105 of the portable terminal 100 according to the embodiment in reproducing a recorded voice sound.

In the processing flow as illustrated in FIG. 8, the reproduction processor 204 first determines, at S1, whether a section to be reproduced next is a section tagged by a user (a tagged section).

At S1, when the reproduction processor 204 determines that the section to be reproduced next is a section tagged by the user, the processing advances to S2. At S2, filter-factor calculator 207 calculates a filter factor for allowing the user to feel that a voice sound is heard from behind the user.

On the other hand, at S1, when the reproduction processor 204 determines that the section to be reproduced next is not a section tagged by the user, the processing advances to S3. Then, at S3, the reproduction processor 204 specifies the speaker of the section to be reproduced next, and the processing advances to S4.

At S4, the reproduction processor 204 specifies an arrival direction corresponding to the speaker specified at S3. To be more specific, the reproduction processor 204 specifies the arrival direction corresponding to the speaker specified at S3 from a positional relationship between respective speakers that is acquired at the time of recording a voice sound, or the arrival direction of the voice sound for each speaker set by the arrival-direction setting module 208 based on the operation of the user on the image IM2 in FIG. 6 or the image IM3 in FIG. 7, or the like. Furthermore, the processing advances to S5.

At S5, the filter-factor calculator 207 calculates a filter factor for allowing the user to feel that a voice sound is heard from the arrival direction specified at S4.

When the filter factor is calculated at S2 or S5, the processing advances to S6. Then, at S6, the calculated filter factors are set to the respective filters 111B and 111C,and the processing returns.

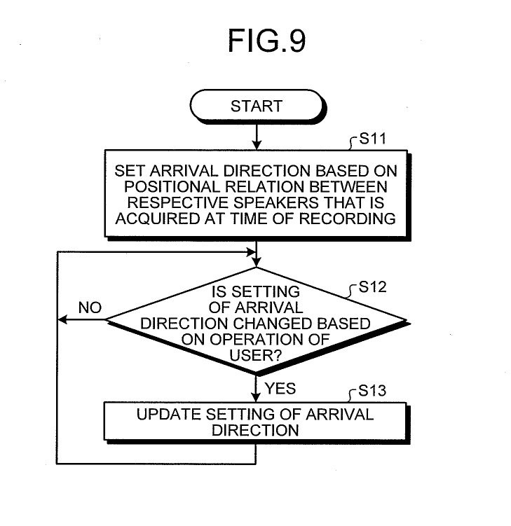

Next, in reference to FIG. 9, the explanation is made with respect to a processing flow performed by the CPU105 of the portable terminal 100 when the arrival direction of a voice sound for each speaker are set, in the embodiment.

In the processing flow as illustrated in FIG. 9, at S11, the arrival-direction setting module 208 first sets, as default setting, an arrival direction based on the positional relationship between respective speakers that is acquired by the recording processor 203 at the time of recording a voice sound, and then the processing advances to S12.

At S12, the arrival-direction setting module 208 determines whether a setting of the arrival direction based on the operation of the user on the image IM2 in FIG. 6 or the image IM3 in FIG. 7 is changed. The processing at S12 is repeated until the arrival-direction setting module 208 determines that the setting of the arrival direction based on the operation of the user is changed. At S12, when the arrival-direction setting module 208 determines that the setting of the arrival direction based on the operation of the user is changed, the processing advances to S13.

At S13, the arrival-direction setting module 208 updates the setting of the arrival direction depending on the operation of the user at S12, and then the processing returns to S12.

As explained heretofore, the CPU 105 according to the embodiment executes the recording/reproduction program 202 so as to record the signal of a voice sound including a plurality of voice sections of a plurality of speakers, to distinguishably display the voice sections of the speakers, to receive the operation for specifying the first voice sound of the first voice section of the first speaker out of the voice sections of the speakers, to output the first voice sound of the first voice section in a first output form by using the two loudspeakers 104A and 104B, and to output the second voice sound of the second voice section other than the first voice section in a second output form by using the two loudspeakers 104A and 104B. Here, the first output form of the first voice sound and the second output form of the second voice sound are different from each other. Accordingly, a voice sound of a section specified by a user is auditorily distinguishable from other voice sounds.

Furthermore, in the embodiment, in the first output form of the first voice sound, two voice sounds output from the respective two loudspeakers 104A and 104B based on the first voice sound are output in such a manner that the two voice sounds are enhanced each other in the second direction other than the first direction toward the portable terminal 100. Accordingly, when the voice sound of the section specified by a user is reproduced, the attention of the user can be easily attracted.

Furthermore, in the embodiment, a third direction and a fourth direction are different from each other, the third direction being a direction in which two voice sounds output from the respective two loudspeakers 104A and 104B based on the voice section of a first speaker out of a plurality of speakers are enhanced each other, the fourth direction being a direction in which two voice sounds output from the respective two loudspeakers 104A and 104B based on the voice section of a second speaker different from the first speaker are enhanced each other. Accordingly, the speaker of the voice sound that is currently reproduced is auditorily distinguishable.

Furthermore, the CPU105 in the embodiment is configured to execute the recording/reproduction program 202 so as to set the above-described third direction and the fourth direction based on the positional relationship between the first speaker and the second speaker at the time of recording the signal of a voice sound, or a user's operation. Accordingly, the arrival direction of the voice sound for each speaker can be easily set or changed.

Meanwhile, the recording/reproduction program 202 according to the embodiment is provided as an installable or executable computer program product. That is, the recording/reproduction program 202 is comprised in a computer program product having a non-transitory, computer-readable recording medium such as a CD-ROM, a flexible disk (FD), a CD-R, or a digital versatile disc (DVD).

The recording/reproduction program 202 maybe stored in a computer connected to a network such as the Internet, and provided or distributed via the network. Furthermore, the recording/reproduction program 202 may be provided in a state of being incorporated in a ROM or the like in advance.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of an electronic device for outputting a sound from loudspeakers, the method comprising:
recording an audio signal comprising voice sections;
displaying the voice sections, wherein speakers of the voice sections are visually distinguishable;
designating a first voice section of a first speaker;
designating a second voice section of a second speaker;
outputting signals of the first voice section from the loudspeakers in a first output form; and
outputting signals of the second voice section from the loudspeakers in a second output form different from the first output form.

2. The method of claim 1, wherein signals of the first voice section output from the loudspeakers are enhanced in a first direction, and signals of the second voice section output from the loudspeakers are enhanced in a second direction different from a first direction, the first direction being toward the electronic device.

3. The method of claim 1, wherein signals of the first voice section output from the loudspeakers are enhanced in a third direction, and signals of the second voice sound output from the loudspeakers are enhanced in a fourth direction, the third direction different from the fourth direction.

4. The method of claim 3, wherein the third direction and the fourth direction are set based on positional relationship between the first speaker and the second speaker at a time of recording the audio signal of voice of each speaker, or designated by an operation.

5. The method of claim 1, wherein signals of the first voice section output from the loudspeakers and signals of the second voice section output from the loudspeakers vary in volume from each other.

6. An electronic device for outputting a sound from loudspeakers, the electronic device comprising:
a hardware processor configured to:
record an audio signal comprising voice sections;
display the voice sections, wherein speakers of the voice sections are visually distinguishable;
designate a first voice section of a first speaker;
designate a second voice section of a second speaker;
output signals of the first voice section from the loudspeakers in a first output form; and
output signals of the second voice section from the loudspeakers in a second output form different from the first output form.

7. The electronic device of claim 6, wherein signals of the first voice section output from the loudspeakers are enhanced in a first direction, and signals of the second voice section output from the loudspeakers are enhanced in a second direction different from a first direction, the first direction being toward the electronic device.

8. The electronic device of claim 6, signals of the first voice section output from the loudspeakers are enhanced in a third direction, and signals of the second voice sound output from the loudspeakers are enhanced in a fourth direction, the third direction different from the fourth direction.

9. The electronic device of claim 8, wherein the third direction and the fourth direction are set based on positional relationship between the first speaker and the second speaker at a time of recording the audio signal of voice of each speaker, or designated by an operation.

10. The electronic device of claim 6, wherein signals of the first voice section output from the loudspeakers and signals of the second voice section output from the loudspeakers vary in volume from each other.

11. A computer program product having a non-transitory computer readable medium comprising programmed instructions for outputting a sound from loudspeakers, wherein the instructions, when executed by a computer, cause the computer to perform:
recording an audio signal comprising voice sections;
displaying the voice sections, wherein speakers of the voice sections are visually distinguishable;
designating a first voice section of a first speaker;
designating a second voice section of a second speaker;
outputting signals of the first voice section from the loudspeakers in a first output form; and
outputting signals of the second voice section from the loudspeakers in a second output form different from the first output form.

12. The computer program product of claim 11, wherein signals of the first voice section output from the loudspeakers are enhanced in a first direction, and signals of the second voice section output from the loudspeakers are enhanced in a second direction different from a first direction, the first direction being toward an electronic device.

13. The computer program product of claim 11, wherein signals of the first voice section output from the loudspeakers are enhanced in a third direction, and signals of the second voice sound output from the loudspeakers are enhanced in a fourth direction, the third direction different from the fourth direction.

14. The computer program product of claim 13, wherein the third direction and the fourth direction are set based on positional relationship between the first speaker and the second speaker at a time of recording the audio signal of voice of each speaker, or designated by an operation.

15. The computer program product of claim 11, wherein signals of the first voice section output from the loudspeakers and signals of the second voice section output from the loudspeakers vary in volume from each other.
